(19) United States
(12) Patent Application Publication
(10) Pub. No.: US 2007/0171171 A1
(43) Pub. Date: Jul. 26, 2007

(54) Display device and driving method

(75) Inventors: Jason R. Hector, Redhill (GB); Steven C. Deane, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,846

(22) PCT Filed: Jan. 4, 2005
(86) PCT No.: PCT/IB05/50025

§ 371 Date: Jun. 27, 2006

(30) Foreign Application Priority Data
Jan. 6, 2004 (GB) 0400109.5

(51) Int. Cl. G09G 3/36

(52) U.S. Cl. 345/98

(57) ABSTRACT

A display controller (40), comprising: a processor (62) for providing row selection pulses (52, 54, 56) for a display comprising M rows of pixels, the row selection pulses (52, 54, 56) having respective durations (t1, t2, t3 . . . tM) that increase from the pulse (52) for row 1 to the pulse (56) for row M. The processor (62) may retime image data (72) for synchronisation with the increase in the pulse duration, for example by writing incoming data (72) in to a buffer (64) at the rate the incoming data (72) is received and reading the data out from the buffer (64) at a rate corresponding to the increase in the pulse duration. Also described is a display device comprising the display controller (40), and a method of driving the display device using the display controller (40). The increase in row selection pulse duration (t1, t2, t3 . . . tM) is arranged to correspond, with a desired level of precision, to an increasing charging time of the pixels of the rows.

The present invention relates to display devices comprising pixels arranged in rows and columns, to display controllers for such display devices, and to driving or addressing methods for such display devices.

Known display devices include liquid crystal, polymer light emitting diode, organic light emitting diode, field emission, switching mirror, electrophoretic, electrochromic and micro-mechanical display devices. Such devices comprise an array of pixels. In operation, such a display device is addressed or driven with data (e.g. video) signals containing individual display settings (e.g. intensity level, often referred to as grey-scale level, and/or colour) for each pixel. This data is “display data” or “image data, and is often simply referred to as “data” in this art.

Each pixel is provided with its respective display setting by an addressing scheme in which rows of pixels are driven one at a time, and each pixel within that row is provided with its own setting by different display data being applied to each column of pixels. Each addressing of all the rows, with corresponding application of display data to each column during each addressing of a row, constitutes a frame. Conventionally, during a frame, each row is addressed for an equal amount of time.

Display data is provided from an external source, e.g. a personal computer. The display data is provided on a frame-by-frame basis, at a given frame frequency. That is, the display data is refreshed for each frame to be displayed.

A typical frame frequency is 50 Hz, i.e. the frame time is 0.02s. A typical display may comprise 1000 rows of pixels. In such a display, the time available for the addressing of an individual row in each frame, hereinafter referred to as the “row time”, is 0.02s/1000=20 μs (if we ignore, for the purposes of the present account, the setting up time of each frame). The “row time” is also known as the “video signal line time”.

This row time is the time available for charging each pixel of the row with the display data voltage applied to its respective column. However, in practical displays, the column takes a certain amount of time to reach the full level of the display data voltage when the display data voltage is applied to it, due to an effective resistance-capacitance (RC) time constant of the column of pixels and associated connections. The row time can therefore place performance limits on displays, e.g. number of rows and/or frame frequency, at least as a trade-off between these factors and performance criteria, since for example the pixels may not have an opportunity to become fully charged.

Furthermore, the commercial and technical trend is for larger displays and/or displays with higher resolution, and for displays with increased frame frequency. Such displays have reduced row times, For example, a display with 2000 lines and a 100 Hz frame frequency has a row time of only 5 μs. Such displays are therefore even more potentially impeded by virtue of the row time restriction compared to the fact that in practical displays the column takes a certain amount of time to reach the full level of the display data voltage when the display data voltage is applied to it.

The present inventors have realised that the effective resistance-capacitance (RC) of the column of pixels and associated connections is distributed along the column of pixels such that, for example, for a given column of pixels, the pixel nearest to where the display data voltage is applied, (in terms of the electrical connection, as opposed, say, to the strict distance “as the crow flies”) has the lowest RC time constant of the pixels in that column, whereas the pixel furthest from where the display data voltage is applied (again in terms of the electrical connection, as opposed, say, to the strict distance “as the crow flies”) has the highest RC time constant of the pixels in that column. (For convenience, the pixel nearest to where the display data voltage is applied may be thought of as the pixel “nearest the column driver” or “at the top of the column”; likewise the pixel furthest from where the display data voltage is applied may be thought of as the pixel “furthest from the column driver” or “at the bottom of the column”.) The intermediate pixels have a varying RC time constant that increases from the lowest value at the top of the column to the highest value at the bottom of the column. The present inventors have further realised that, since in conventional displays an equal row time is applied to each pixel in a column, the row time may be too generous for the majority of the higher pixels, in order to allow sufficient charging time for the lower pixels; or, in displays at their limit, the equal row time may not be sufficiently long to allow a desired degree of charging of lower pixels in a column even if that row time is sufficient to allow a desired degree of charging for pixels higher in the column.

In a first aspect, the present invention provides a display controller for providing respective row selection pulses for each row 1 to M of a display, the row selection pulses having respective durations that increase from the pulse for row 1 to the pulse for row M, the increase in the pulse duration being one of the following: (a) on a row-by-row basis; or (b) on a set of rows-by-set of rows basis, where a set of rows comprises plural consecutive rows; or (c) on a mixture of a row-by-row basis and a set of rows-by-set of rows basis, where a set of rows comprises plural consecutive rows. In other words, the respective pulse durations increase along each column of pixels from the pixel nearest to where display data voltage is to be applied (in terms of the electrical connection) to the pixel furthest from where the display data voltage is to be applied (in terms of the electrical connection). Or, in yet further words, the respective pulse durations vary as a function of the particular row such that they increase in the direction along the column from row 1 to row M. Or, in yet further words, in a frame, the row selection pulse for a given row or set of consecutive rows is longer than the row selection pulse for the row preceding the given row.

The display controller may further be arranged to receive image data for the display, and retime the image data for synchronisation with the increase in the row selection pulse duration.

The display controller may comprise a processor and a data buffer, the buffer and the processor being arranged for the processor to retime the data by writing incoming data in to the buffer at the rate the incoming data is received and reading the data out from the buffer at a row rate corresponding to the increase in the row selection pulse duration. This arrangement advantageously requires only a relatively small amount of memory space in the buffer.

The number of rows in a given set may be less than the number of rows in one or more preceding sets. This tends to allow a balance between limiting the total amount of processing by only having a certain number of sets to cover a relatively large proportion of the rows, staring from row 1, yet allowing a reasonably high precision for the rows closer to row M, where the above identified problems arising from the increased charging times will be most severe.

The total duration of the row selection pulses for all the rows may be substantially equal to a frame time, less a setting up time for a frame, of the display.

In a further aspect, the present invention provides a display device comprising a display controller according to any of the aspects described above.

In a further aspect, the present invention provides a method of driving a display device of the type described in the preceding paragraph, the method comprising providing respective row selection pulses for each row 1 to M of the display with increasing row selection pulse duration from row 1 to row M, in a manner corresponding to any of the various aspects of the display controller functionality described above.

In a further aspect, the present invention provides a display controller, comprising: a processor for providing row selection pulses for a display comprising M rows of pixels, the row selection pulses having respective durations that increase from the pulse for row 1 to the pulse for row M. The processor may retime image data for synchronisation with the increase in the pulse duration, for example by writing incoming data in to a buffer at the rate the incoming data is received and reading the data out from the buffer at a rate corresponding to the increase in the pulse duration. In further aspects the present invention provides a display device comprising the display controller, and a method of driving the display device using the display controller. The increase in row selection pulse duration may be arranged to correspond, with a desired level of precision, to an increasing charging time of the pixels of the rows.

The present invention tends to alleviate problems arising from the form of the distributed effective resistance-capacitance (RC) occurring along a column of pixels leading to a distributed charging time that increases accordingly.

Embodiments of the present invention will now be described, by way of example, with reference to the accompanying drawings, in which:

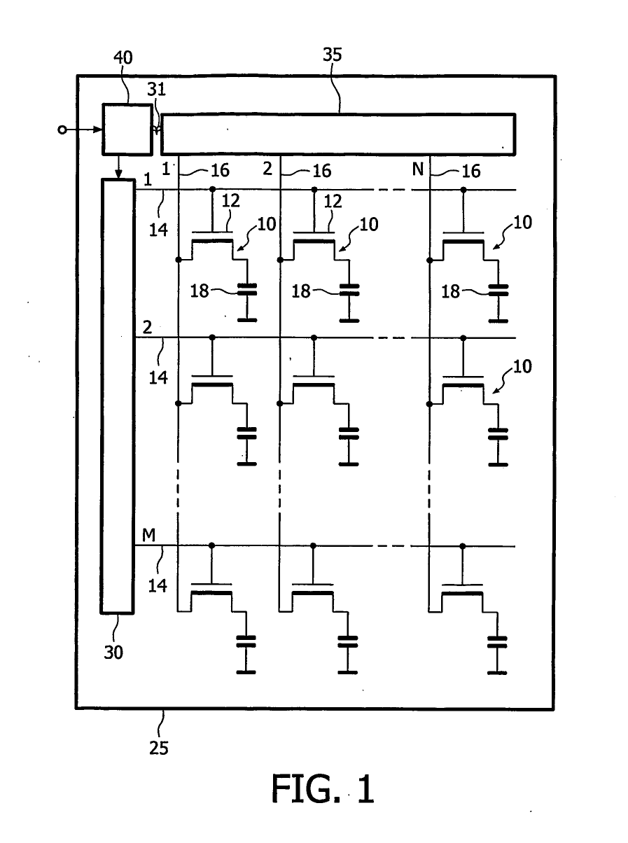

FIG. 1 is a schematic diagram of an active matrix liquid crystal display device in which a first embodiment of the invention is implemented;

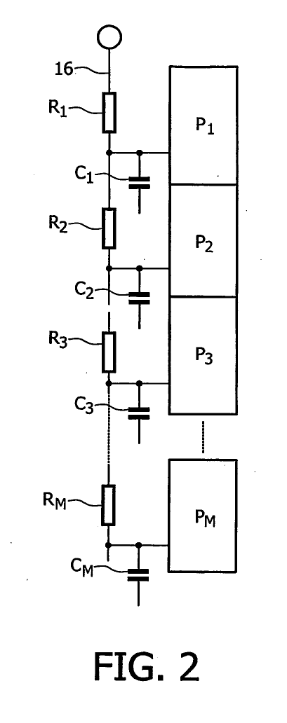

FIG. 2 is a schematic illustration of an electrical circuit representation of the RC load on a column of the liquid crystal display device of FIG. 1;

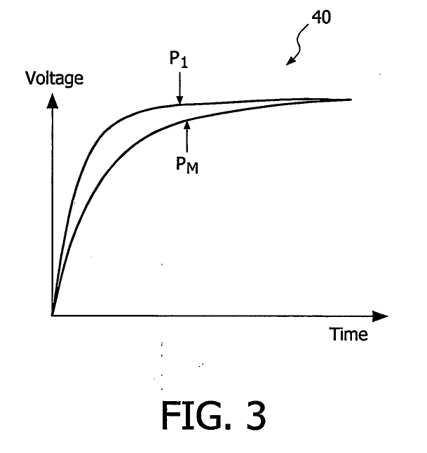

FIG. 3 is a schematic illustration, not to scale, showing an increasing charging time of pixels down a column of a liquid crystal display device;

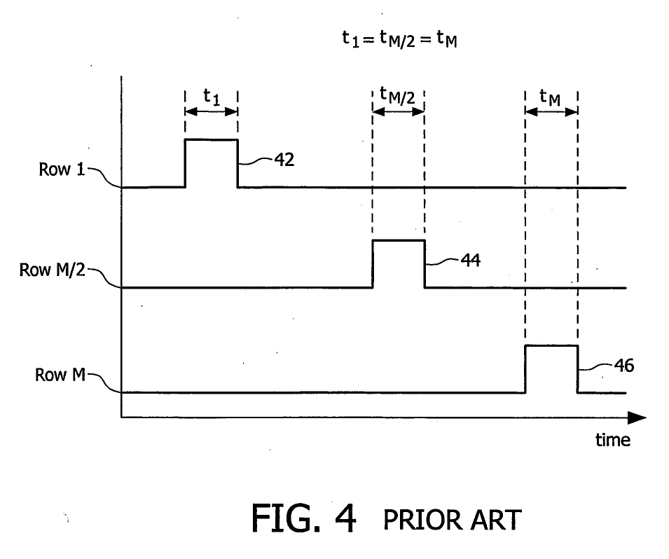

FIG. 4 shows, for a prior art row addressing scheme, row selection pulses as applied respectively to rows 1, M/2, and M of a display device;

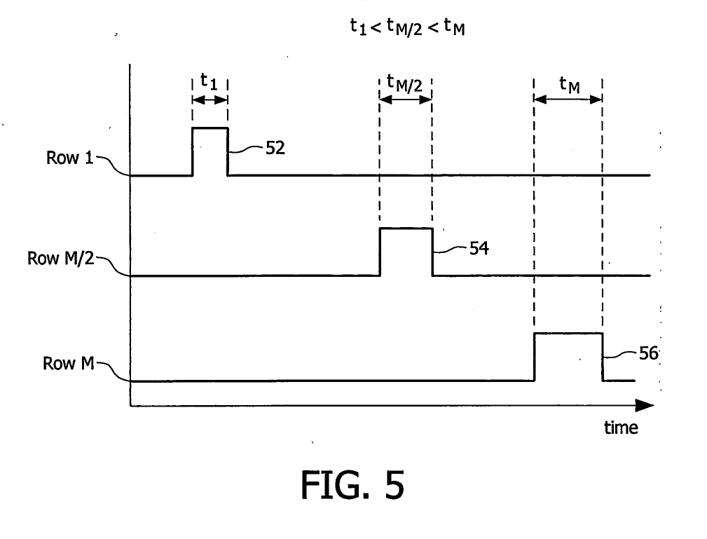

FIG. 5 is a schematic illustration, not to scale, in the same format as FIG. 4, showing row selection pulses as applied respectively to rows 1, M/2, and M of a display device according to the first embodiment; and

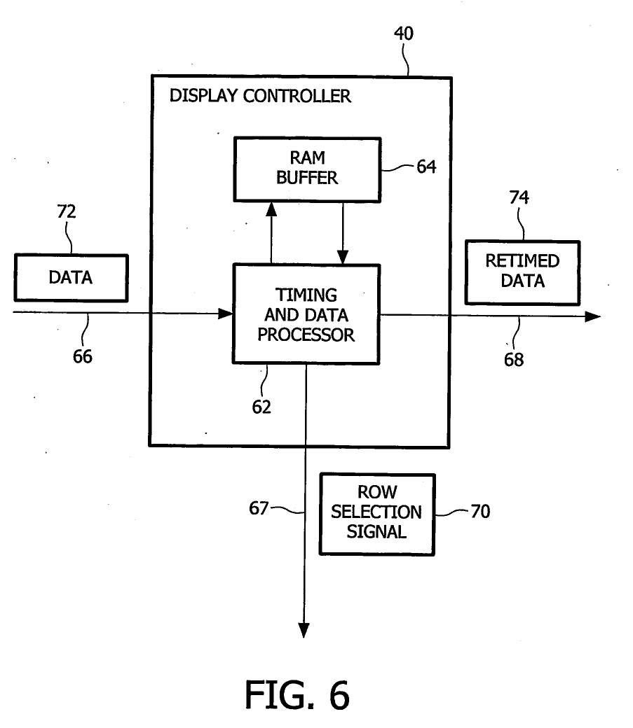

FIG. 6 is a block diagram showing further details of a display controller being part of the liquid crystal display device of FIG. 1.

FIG. 1 is a schematic diagram of an active matrix liquid crystal display device in which a first embodiment of the invention is implemented. The display device, which is suitable for displaying video pictures, comprises an active matrix addressed liquid crystal display panel 25 having a row and column array of pixels which consists of M rows (1 to M) with N horizontally arranged pixels 10 (1 to N) in each row. Only a few of the pixels are shown for simplicity.

Each pixel 10 is associated with a respective switching device in the form of a thin film transistor, TFT, 12. The gate terminals of all TFTs 12 associated with pixels in the same row are connected to a common row conductor 14 to which, in operation, selection (gating) signals are supplied. Likewise, the source terminals associated with all pixels in the same column are connected to a common column conductor 16 to which data (video) signals are applied. The drain terminals of the TFTs are each connected to a respective pixel electrode 18 forming part of, and defining, the pixel. The conductors 14 and 16, TFTs 12 and electrodes 18 are carried on one transparent plate while a second, spaced, transparent plate carries an electrode common to all the pixels, usually referred to as the common electrode. Liquid crystal is disposed between the plates.

The display panel is operated as follows. Light from a light source disposed on one side enters the panel and is modulated according to the transmission characteristics of the pixels 10. The device is driven one row at a time by scanning the row conductors 14 sequentially with a selection (gating) signal so as to turn on each row of TFTs in turn and applying data (video) signals to the column conductors for each row of picture display elements in turn as appropriate and in synchronism with the selection signals so as to build up a complete display frame (picture). Using one row at time addressing, all TFTs 12 of the selected row are switched on for a period determined by the duration of the selection signal corresponding to a video signal line time during which the data signals are transferred from the column conductors 16 to the pixel electrodes 18.

Upon termination of the selection signal, the TFTs 12 of the row are turned off for the remainder of the frame period, thereby isolating the pixels from the conductors-16 and ensuring the applied charge is stored on the pixels until the next time they are addressed in the next frame period.

The row conductors 14 are supplied successively with selection signals by a row driver circuit 30 comprising a digital shift register controlled by the selection signal, comprising timing pulses, from a display controller 40. In the intervals between selection signals, the row conductors 14 are supplied with a substantially constant reference potential by the row driver circuit 30. Video information signals are supplied to the column conductors 16 from a column driver circuit 35, here shown in basic form, comprising one or more shift register/sample and hold circuits. The column driver circuit 35 is supplied over a bus 31 with video signals from the display controller 40. The column driver circuit 35 is also supplied over the bus 31 with timing pulses from the display controller 40. The video signals and timing pulses are supplied in synchronism with row scanning to provide serial to parallel conversion appropriate to the row at a time addressing of the panel 25.

Other details of the liquid crystal display device, except where otherwise is stated below in relation to the timing of selection signals, and corresponding adaption of other timing and data signals, may be as per any conventional active matrix liquid crystal display device. In this particular embodiment such other details are the same as, and operate the same as, the liquid crystal display device disclosed in U.S. Pat. No. 5,130,829, the contents of which are contained herein by reference.

FIG. 2 is a schematic illustration of an electrical circuit representation of the RC load on a column of the liquid crystal display panel 25. As described with reference to FIG. 1, a column conductor 16 is connected each of the pixels P₁, P₂, P₃ . . . P_{M} of the column. The connection comprises a distributed RC load, as shown. Between the column conductor 16 and each pixel P₁, P₂, P₃ . . . P_{M} there is a respective effective capacitance C₁, C₂, C₃ . . . C_{M}. Furthermore, the column conductor 16 has an effective accumulative resistance with respect to respective pixels, i.e. there is an effective resistance R₁ to the pixel P₁, an additional effective resistance R₂ to the pixel P₂, an additional effective resistance R₃ to the pixel R₃, and so on to an additional effective resistance R_{M} to the pixel P_{M}.

The effect of the effective capacitances C₁, C₂, C₃ . . . C_{M} and effective resistances R₁, R₂, R₃ . . . R_{M} is to form a distributed RC load that increases down the column from pixel P₁ to P_{M} (i.e. from row 1 to row M).

An effect of this increasing RC load is that the charging time of the pixels increases down the column from pixel P₁ to P_{M} (i.e. from row 1 to row M). The detailed form of this increase will depend on the design and materials of a particular display panel under consideration, and will tend to be a somewhat complex relationship. However, FIG. 3 is a schematic illustration, not to scale, showing this increasing charging time in a qualitative sense. More particularly, FIG. 3 shows representative pixel charging curves 40, in terms of voltage against time, for the pixels P₁ and P_{M}.

The details of the liquid crystal display panel 25 of this embodiment, including the RC characteristics shown in FIG. 2, and resulting increasing charging time shown in FIG. 3, are common with prior art liquid crystal display panels. However, unlike the case of prior art liquid crystal display panels, the liquid crystal display panel 25 of this embodiment has been adapted to provide a row addressing scheme that tends to alleviate detrimental effects arising from the increasing charging time.

This will best be appreciated by first considering the following summary of a typical prior art row addressing scheme, which is illustrated schematically, i.e. not to scale, in FIG. 4. More particularly, FIG. 4 shows, for the prior art row addressing scheme, row selection pulses 42, 44, 46 as applied respectively to each of the following rows: row 1, row M/2, and row M (row selection pulses are in fact applied to all of rows 1 to M, but for clarity only the three examples mentioned are shown in FIG. 4). The respective duration of each row selection pulse is indicated, where t₁ is the duration of the row selection pulse 42 for row 1; t_{M/2} is the duration of the row selection pulse 44 for row M/2; and t_{M} is the duration of the row selection pulse 46 for row M. In the prior art row addressing scheme, the duration of the row selection pulses of all the rows is equal, i.e. in terms of FIG. 4, t₁=t_{M/2}=t_{M}.

FIG. 5 is a schematic illustration, in the same format as FIG. 4, of the row addressing scheme of this embodiment. FIG. 5 shows, for the row addressing scheme of this embodiment, row selection pulses 52, 54, 56 as applied respectively to each of the following rows: row 1, row M/2, and row M (row selection pulses are in fact applied to all of rows 1 to M, but for clarity only the three examples mentioned are shown in FIG. 5). The respective duration of each row selection pulse is indicated, where t₁ is the duration of the row selection pulse 52 for row 1; t_{M/2} is the duration of the row selection pulse 54 for row M/2; and t_{M} is the duration of the row selection pulse 56 for row M. In the row addressing scheme of this embodiment, the duration of the row selection pulses of the respective rows increases down the column from row 1 to row M, i.e. in terms of FIG. 4, t₁<t_{M/2}<t_{M}.

The increase in duration of the row selection pulses of the respective rows, as a function of the particular row for each row between row 1 and row M, is arranged to correspond, with a desired level of precision, to the increasing charging time of the pixels of the rows. This involves a trade-off in is that implementing a higher level of precision will provide more accurate compensation and hence more performance benefit, but at the cost of more complicated processing. The level of precision will be implemented by the skilled person in view of this trade-off according to the particular display device and circumstances under consideration. For example, it may be appropriate for simplicity to implement the increase in duration of the row selection pulses of the respective rows over the course of the rows as a linear increase, even when the increasing charging time of the pixels of the rows is not linear with row number.

Furthermore, as mentioned above in relation to FIG. 3, the detailed form of the increase in charging time of the pixels as a function of the particular row for each row between row 1 and row M will depend on the design and materials of the particular display panel under consideration, and will tend to be a somewhat complex relationship. This is therefore determined, by means of estimation and/or calculation and/or measurements, by the skilled person in a manner chosen as appropriate to the particular display panel to which the present invention is being applied, in light of commercial and/or technical considerations.

Yet further, the increase in duration of the row selection pulses of the respective rows may be implemented in any of the following ways:

(a) On an individual row-by-row basis, i.e. each individual row from row 1 to row M is provided with a different (increasing compared to the preceding row) duration, such that t₁<t₂<t₃<t₄ . . . t_{M-2}<t_{M-1}<t_{M} This gives the most precise compensation, but at a cost of requiring complex processing.

(b) By dividing the rows into equally sized sets or blocks of consecutive rows, e.g. in the case of the display with 1000 rows, i.e. M=1000, by dividing the rows into, say, 10 equal sets of 100 rows, where the first set contains rows 1 to 100, the second set contains rows 101 to 200, and so on. Then each individual set of rows is provided with a different (increasing compared to the preceding set of rows) duration, such that t_{1 to 100}<t_{101 to 200}<t_{201 to 300} . . . <t_{(M-99) to M}. This reduces the level of processing, but still provides a level of compensation over the course of the rows of the display panel. The equally sized blocks may be of any desired size, e.g. in the above example there could be 100 equal sets of 10 rows instead of 10 equal sets of 100 rows. Generally, the lower the number of sets, the simpler the processing, but at a cost of less precision.

(c) By dividing the rows into non-equally sized sets or blocks of consecutive rows, e.g. in the case of the display with 1000 rows, i.e. M=1000, by dividing the rows into, say, 10 sets, where the first 4 sets each have 200 rows, and then the last 10 sets each have 20 rows. This provides a balance between limiting the total amount of processing by only having 4 sets to cover the first 800 lines, where, for example, the charging time may be reasonably well covered by the available addressing time anyway, yet allowing reasonably high precision for the lower rows, in this example rows 801 to 1000, where problems arising from the increased charging times will be most severe. In this example, the sets are divided into two main groups of equally sized sets, but in other examples any spread may be used as required, for example all the sets could contain different numbers of rows.

(d) By any combination of any two or all of the possibilities (a), (b) and (c) described above.

In all the above embodiments, the total duration of the row selection pulses of all the rows is preferably made equal to the conventional frame time (less the setting up time of each frame).

FIG. 6 is a block diagram showing further details of the display controller 40 described earlier with reference to FIG. 1. The display controller 40 represents an embodiment of apparatus for implementing an increase in duration of the row selection pulses according to any of the schemes described above.

The display controller 40 comprises a timing and data processor 62, typically in the form of an integrated circuit (IC), coupled to a random access memory (RAM) buffer 64.

The display controller 40 further comprises an input 66 for coupling to an external data source, e.g. a pc; an output 67 for coupling to the row driver circuit 30 (as shown in FIG. 1); and an output 68 for coupling to the bus 31/column driver circuit 35 (as shown in FIG. 1).

In operation, the timing and data processor 62 produces a row selection signal 70 and applies this via the output 67 to the row driver circuit 30. As described above, the row selection signal 70 is a timing signal comprising a respective row selection pulse (e.g. 52, 54, 56, as shown in FIG. 5) for each row, the pulses having a duration that increases from the pulse for row 1 to the pulse for row M.

Also, the timing and data processor 62 receives conventionally timed input video data 72 via the input 66. The timing and data processor 62 controls retiming of the data 72, by writing the incoming data 72 in to the RAM buffer 64 at the constant row rate it is received, and reading out the data at a row rate corresponding to the increasing duration of row selection pulses described above, to provide retimed data 74.

The timing and data processor 62 outputs the retimed display data 74 via output 68 to the bus 31 and hence to the column driver circuit 35.

In this way the data signals applied by the column driver circuit 35 to the column conductors 16 are synchronised with the varying row selection signal (i.e. varying row selection pulse duration) applied by the row driver circuit 30 to the row conductors 14.

Often the amount of memory space required in the RAM buffer 64 will be considerably less than that required to store a whole frame of data, as follows. At the start of a frame the display is being addressed faster than the data is arriving, whereas at the end of the frame time the data is arriving faster than the display is being addressed. This implies that the data arriving during the second half of the frame is gradually filling the memory. During the first half of the frame time the memory is gradually read out again. Assuming the overall frame time is unchanged, and the display is being constantly addressed, the total memory required in the RAM buffer 64 is therefore less, often considerably less, than a frame store. For example, in the case of the above described 1000 line display at 50 Hz, the nominal row time is 20 μs. This gives, for a linear continuous variation in row selection duration from 16 μs for row 1 to 24 μs for row 1000, a memory requirement of just 50 rows of data for the RAM buffer 64.

In the above embodiments, a particular display controller, including a particular processor and buffer arrangement, and a particular row and column driver arrangement, are employed. It will be appreciated that in other embodiments the details of any or all of these elements may be different to those employed in the above described embodiments. Furthermore, although in the above described embodiments the processing of video data signals and/or row selection signals to provide increasing duration is performed by elements in the display device, in other embodiments such processing may be performed remote from a display device. For example, a standardised form of an increasing row selection pulse duration scheme may be agreed upon, and video feed could then be provided already prepared according to this scheme.

The above embodiments are implemented in a relatively large display, and indeed the present invention is of particular potential benefit for large displays, e.g. large number of lines, and/or displays with high resolution, and/or displays with high frame frequency. However, it will be appreciated that the present invention may nevertheless also be applied to displays of lesser size/resolution/frame frequency.

The above embodiments are implemented in an active matrix liquid crystal display device comprising an active matrix addressed liquid crystal display panel. However, in other embodiments, the present invention may be implemented in other types of array display devices, including for example plasma, polymer light emitting diode, organic light emitting diode, field emission, switching mirror, electrophoretic, electrochromic and micro-mechanical display devices.

1. A display controller, comprising:
a processor (62) for providing row selection signals for a display comprising M rows of pixels, wherein the row selection signals comprise a respective row selection pulse (52, 54, 56) for each row, and the row selection pulses (52, 54, 56) have respective durations (t₁, t₂, t₃ . . . t_{M}) that increase from the pulse for row 1 to the pulse for row M, the increase in the pulse duration being one of the following:
(a) on a row-by-row basis; or
(b) on a set of rows-by-set of rows basis, where a set of rows comprises plural consecutive rows; or
(c) on a mixture of a row-by-row basis and a set of rows-by-set of rows basis, where a set of rows comprises plural consecutive rows.

2. A display controller according to claim 1, wherein the processor (62) is further for receiving image data (72) for the display, and retiming the image data (72) for synchronisation with the increase in the row selection pulse duration.

3. A display controller according to claim 2, further comprising a buffer (64), wherein the buffer (64) and the processor (62) are arranged for the processor (62) to retime the data by writing incoming data (72) in to the buffer (64) at the rate the incoming data (72) is received and reading the data out from the buffer (64) at a row rate corresponding to the increase in the row selection pulse duration.

4. A display controller according to claim 1, wherein the number of rows in a given set is less than the number of rows in one or more preceding sets.

5. A display controller according to claim 1, wherein the total duration of the row selection pulses for all the rows is substantially equal to a frame time, less a setting up time for a frame, of the display.

6. A display device, comprising an array of pixels arranged in M rows and N columns, a row driver circuit (30), and a display controller (40), the display controller (40) being arranged to provide row selection pulses (52, 54, 56) to the row driver circuit (30), the row selection pulses (52, 54, 56) having respective durations (t₁, t₂, t₃ . . . t_{M}) that increase from the pulse for row 1 to the pulse for row M, the increase in the pulse duration being one of the following:
(a) on a row-by-row basis; or
(b) on a set of rows-by-set of rows basis, where a set of rows comprises plural consecutive rows; or
(c) on a mixture of a row-by-row basis and a set of rows-by-set of rows basis, where a set of rows comprises plural consecutive rows.

7. A display device according to claim 6, wherein the processor (62) is further for receiving image data (72) for the display, and retiming the image data (72) for synchronisation with the increase in the row selection pulse duration.

8. A display device according to claim 7, further comprising a buffer (64), wherein the buffer (64) and the processor (62) are arranged for the processor (62) to retime the data (72) by writing incoming data (72) in to the buffer (64) at the rate the incoming data (72) is received and reading the data out from the buffer (64) at a row rate corresponding to the increase in the row selection pulse duration.

9. A display device according to claim 6, wherein the number of rows in a given set is less than the number of rows in one or more preceding sets.

10. A display device according to claim 6, wherein the total duration of the row selection pulses for all the rows is substantially equal to a frame time, less a setting up time for a frame, of the display.

11. A method of driving a display device, the display device comprising an array of pixels arranged in M rows and N columns, the method comprising:
providing row selection pulses (52, 54, 56) to each row in turn, the row selection pulses (52, 54, 56) having respective durations (t₁, t₂, t₃ . . . t_{M}) that increase from the pulse for row 1 to the pulse for row M, the increase in the pulse duration being one of the following:
(a) on a row-by-row basis; or
(b) on a set of rows-by-set of rows basis, where a set of rows comprises plural consecutive rows; or
(c) on a mixture of a row-by-row basis and a set of rows-by-set of rows basis, where a set of rows comprises plural consecutive rows.

12. A method of driving a display device according to claim 11, further comprising retiming image data (72) for synchronisation with the increase in the row selection pulse duration.

13. A method of driving a display device according to claiml2, wherein the step of retiming image data (72) comprises writing incoming data (72) in to a buffer (64) at the rate the incoming data (72) is received and reading the data out from the buffer (64) at a row rate corresponding to the increase in the row selection pulse.

14. A method of driving a display device according to claim 11, wherein the number of rows in a given set is less than the number of rows in one or more preceding sets.

15. A method of driving a display device according to claim 11, wherein the total duration of the row selection pulses for all the rows is substantially equal to a frame time, less a setting up time for a frame, of the display.
